(19) United States
(12) Patent Application Publication
(10) Pub. No.: US 2009/0135802 A1
(43) Pub. Date: May 28, 2009

(54) SCALABLE BANDWIDTH SYSTEM, RADIO BASE STATION APPARATUS, SYNCHRONOUS CHANNEL TRANSMITTING METHOD AND TRANSMISSION METHOD

(75) Inventors: Hiroki Haga, Kanagawa (JP); Hidenori Matsuo, Kanagawa (JP); Katsuyoshi Naka, Kanagawa (JP)

Correspondence Address: Dickinson Wright PLLC;James E. Ledbetter, Esq., International Square, 1875 Eye Street, N.W., Suite 1200, Washington, DC, 20006, US

(73) Assignee: Matsushita Electric Industrial Co., Ltd., Osaka (JP)

(21) Appl. No.: 12/064,301

(22) PCT Filed: Aug. 22, 2006
(86) PCT No.: PCT/JP2006/316412

§ 371 Date: Feb. 20, 2008

(30) Foreign Application Priority Data
Jan. 11, 2006 (JP) 2006-004152

(51) Int. Cl. H04J 3/06

(52) U.S. Cl. 370/350

(57) ABSTRACT

A scalable bandwidth system wherein even if a terminal does not know the breakdowns of the services in all of the bandwidths, it can perform a correlation processing of synchronous channels (SCH). A base station repetitively transmits a synchronous channel, by unit of the shortest bandwidth (e.g., 1.25 MHz) of a plurality of bandwidths served by the system, over the whole band of the longest bandwidth (e.g., 5 MHz). The terminal calculates the correlation between a synchronous channel sequence signal of the unit of the shortest bandwidth held in advance and the repetitively transmitted synchronous channel, and determines, as a frame timing, a timing at which the maximum correlation value is obtained.

### TECHNICAL FIELD

The present invention particularly relates to a scalable bandwidth system that enables a radio base station apparatus to support a plurality of maximum bandwidths and flexibly allocate bandwidths radio terminal apparatuses actually use to carry out communication, from the maximum bandwidths, a radio base station apparatus used in the scalable bandwidth system, a synchronization channel transmission method and a transmission method.

### BACKGROUND ART

Conventionally, to perform multicarrier communication typified by the OFDM (Orthogonal Frequency Division Multiplexing) scheme, a radio communication system has been proposed that enables a radio base station apparatus (hereinafter simply “base station”) to support a plurality of maximum bandwidths and flexibly allocate bandwidths radio terminal apparatuses (hereinafter simply “terminals”) actually use to carry out communication, from the maximum bandwidths. This radio communication system is referred to as a scalable bandwidth system (see Non-Patent Document 1, for example).

In a multicarrier communication system, scrambling codes different for each cell are allocated to identify cells to be covered by the base station. A terminal (mobile station) needs to perform cell search upon switching of cells (handover) associated with move or upon intermittent reception, that is, needs to identify scrambling codes to identify the cells.

With cell search in a multicarrier communication system where the bandwidth allocated to each terminal is fixed, the terminal only needs to perform cell search using a received synchronization channel (SCH) according to the bandwidth of the system. Non-Patent Document 2 discloses a general cell search method using an SCH.

A terminal detects the symbol timing (i.e., FFT window timing) in the first step, and detects the frame timing using an SCH in the second step. To be more specific, the terminal performs an FFT on the received signal, demultiplexes the SCH and calculates correlations with SCH replicas. The terminal detects the timing yielding the maximum correlation value out of the calculated correlation values, as a frame timing. The terminal then identifies the scrambling code using a pilot channel or the like in the third step.

Non-Patent Document 3 discloses an example of a configuration of this synchronization channel. As shown in FIG. 1, Non-Patent Document 3 proposes a method of mapping two SCHs by multiplexing the SCHs in the frequency domain. With this method, one OFDM symbol is mapped in one frame, a primary SCH (P-SCH) has a pattern that is common to all cells, and a secondary SCH (S-SCH) has a pattern different for each cell (pattern that shows a code group).

### Non-Patent Document 1: 3GPP TR 25.913 v7.0.0 (2005-06) “Requirements for Evolved UTRA and UTRAN”

Non-Patent Document 2: Yukiko Hanada, Hiroyuki Atarashi, Kenichi Higuchi, and Mamoru Sawahashi, (NTT Docomo) “3-Step Cell Search Performance using frequency-multiplexed SCH for Broadband Multi-carrier CDMA Wireless Access,” RCS2001-91, Jul. 2001

### Non-Patent Document 3: 3GPP R1-050590, NTT DoCoMo “Physical Channels and Multiplexing in Evolved UTRA Downlink” (Jun. 2005)

### DISCLOSURE OF INVENTION

### Problems to be Solved by the Invention

However, for example, the bandwidths the scalable bandwidth system of Non-Patent Document 1 supports, are defined 1.25 MHz, 2.5 MHz, 5 MHz, 10 MHz, 15 MHz and 20 MHz.

The terminal does not know upon initial cell search in which bandwidth the base station provides services, and so does not know which center frequency up to 20 MHz and which bandwidth to use to start trying initial cell search. Therefore, the terminal needs to detect all service bandwidths of the base station and start initial cell search processing.

However, the terminal has no way of knowing details of service bandwidths during cell search, does not know mapping and size of an SCH pattern, and, as a result, is not able to calculate SCH correlations. Consequently, there is a problem that the terminal cannot perform processing after frame synchronization.

This will be described using FIG. 2 and FIG. 3. FIG. 2 illustrates correlation calculation in a multicarrier communication system where a terminal is assigned a fixed bandwidth (5 MHz). The bandwidth is fixed, and so correlation values can be calculated in a simple manner using an SCH replica signal having a cycle equivalent to this bandwidth.

By contrast with this, FIG. 3 illustrates correlation calculation in a scalable bandwidth system where a terminal is assigned a variable bandwidth. The terminal has no way knowing details of service bandwidths transmitted to each terminal from the base station and so does not know mapping and size of an SCH pattern (that is, the terminal does not know which SCH replica to use), and it is thereby difficult to calculate correlation values.

It is therefore an object of the present invention to provide a scalable bandwidth system, radio base station apparatus, synchronization channel transmission method and transmission method that enable a terminal to calculate synchronization channel (SCH) correlation values accurately without knowing details of services with respect to all bandwidths.

### Means For Solving The Problem

The scalable bandwidth system of the present invention enables a radio base station apparatus to support a plurality of maximum bandwidths and flexibly allocate bandwidths radio terminal apparatuses actually use to carry out communication, from the maximum bandwidths, and adopts a configuration including: a radio base station apparatus that transmits a synchronization channel repeatedly in a frequency domain in units of a minimum bandwidth out of a plurality of bandwidths providing services; and a radio terminal apparatus that calculates correlations between a synchronization channel sequence signal of the minimum bandwidth unit provided in advance and the synchronization channels transmitted repeatedly, and detects a timing yielding a maximum correlation value as a frame timing.

According to this configuration, the terminal is able to calculate SCH correlation values accurately without knowing details of services with respect to all bandwidths of the base station.

### Advantageous Effect of the Invention

According to the present invention, the terminal is able to calculate synchronization channel (SCH) correlation values without knowing details of services with respect to all bandwidths, so that it is possible to perform processing after frame synchronization reliably.

### BRIEF DESCRIPTION OF DRAWINGS

FIG. 1 shows a configuration example of a synchronization channel;

FIG. 2 illustrates correlation calculation in a multicarrier communication system where a terminal is assigned a fixed bandwidth;

FIG. 3 illustrates correlation calculation in a scalable bandwidth system where a terminal is assigned a variable bandwidth;

FIG. 4 is a block diagram showing a configuration of a base station of an embodiment;

FIG. 5 is a block diagram showing a configuration of a terminal of the embodiment;

FIG. 6 illustrates the operation of the embodiment;

FIG. 7 illustrates a transmission method of a base station of another embodiment;

FIG. 8 illustrates the transmission method of the base station of another embodiment;

FIG. 9 shows an example where an SCH pattern varies in a center part;

FIG. 10 shows another example where an SCH pattern varies in the center part;

FIG. 11 shows a correspondence relationship between a case where correlation can be calculated and a case where correlation cannot be calculated;

FIG. 12 shows an example of an SCH pattern according to Embodiment 2; and

FIG. 13 shows another example of the SCH pattern according to Embodiment 2.

### BEST MODE FOR CARRYING OUT THE INVENTION

Embodiments of the present invention will be described in detail below with reference to the accompanying drawings.

### Embodiment 1

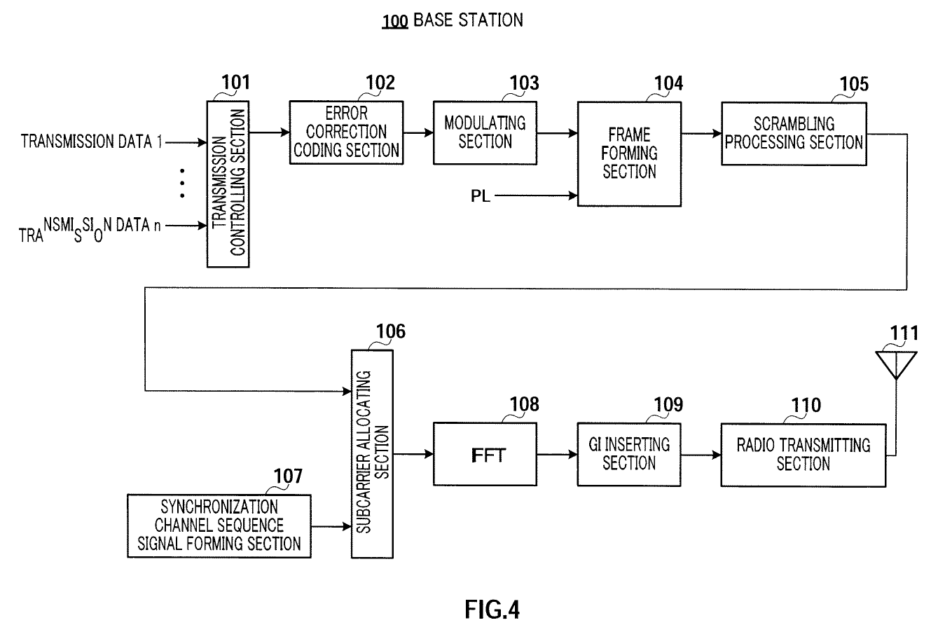

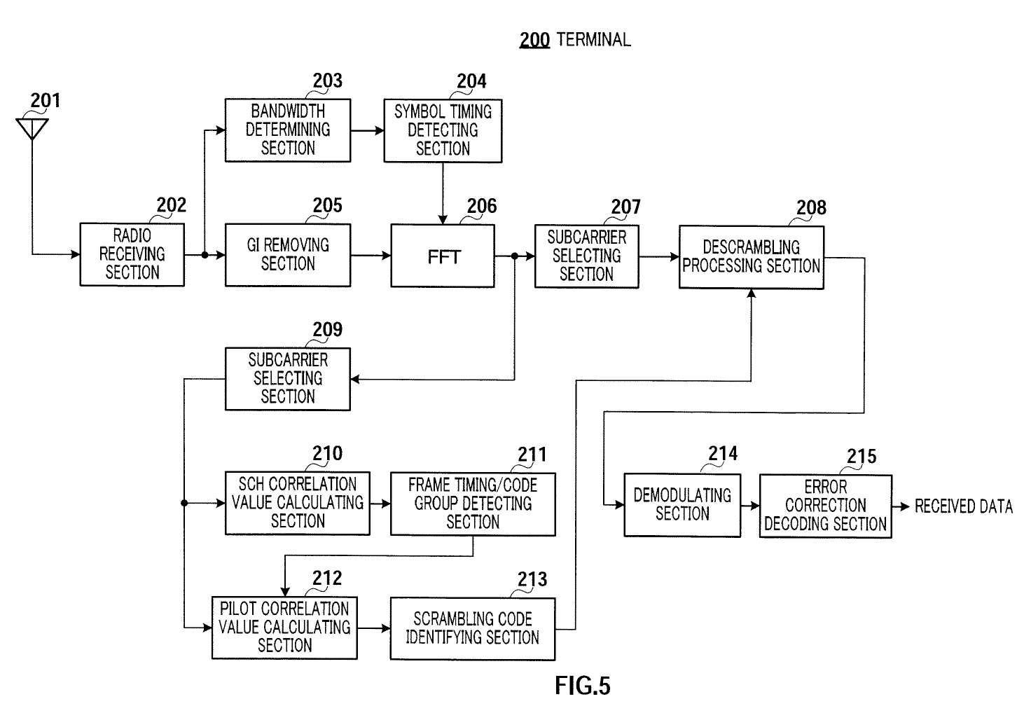

FIG. 4 shows a configuration of a radio base station apparatus (hereinafter “base station”) used in the scalable bandwidth system of this embodiment, and FIG. 5 shows a configuration of a radio terminal apparatus (hereinafter “terminal”) that communicates with base station 100.

Base station 100 flexibly allocates a bandwidth equal to or narrower than the maximum bandwidth out of its supporting bandwidths to each terminal for a communication band and performs OFDM communication with each terminal.

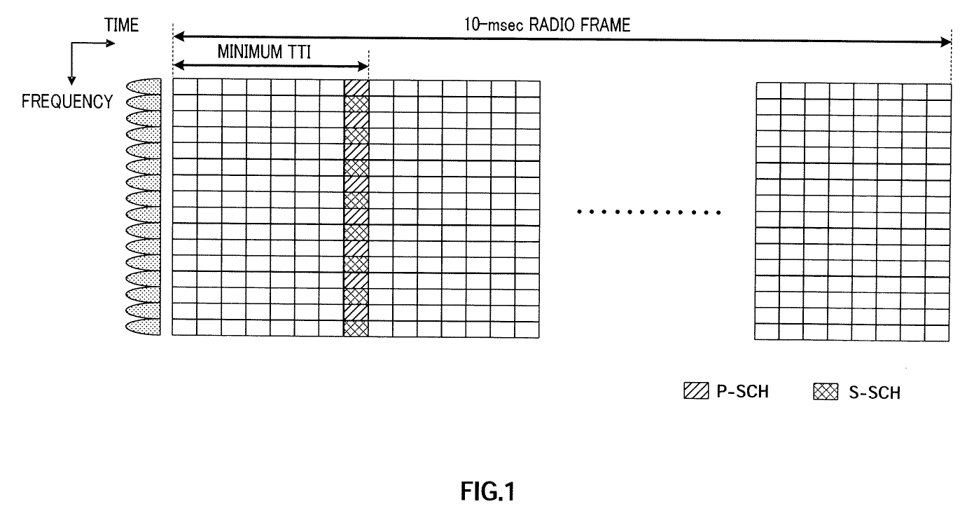

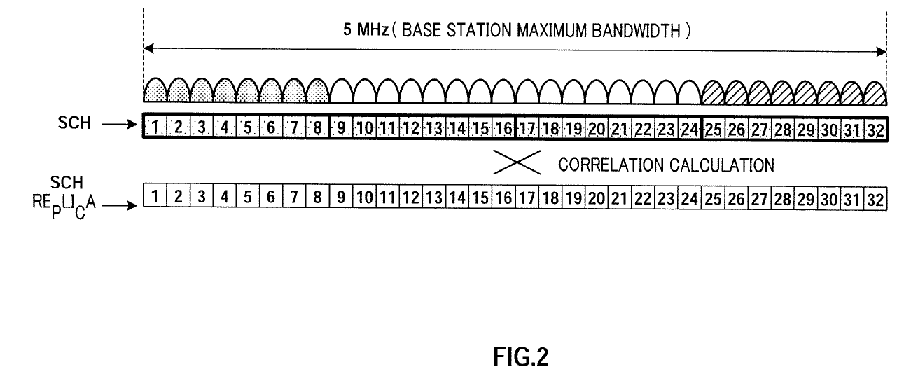

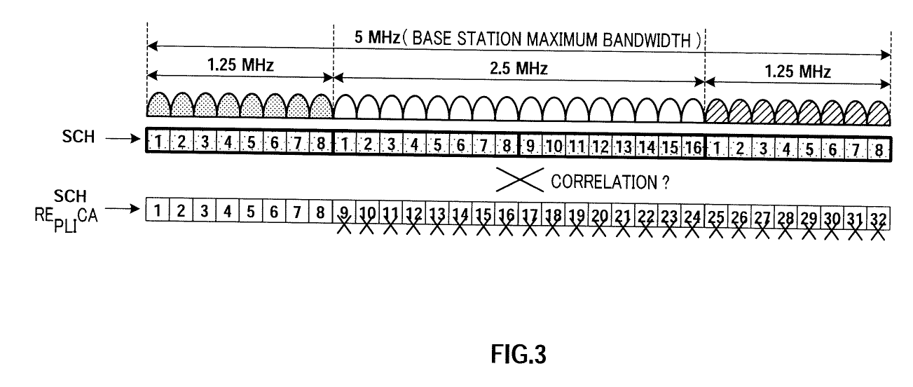

First, the configuration of base station 100 shown in FIG. 1 will be described. Base station 100 inputs to transmission controlling section 101 transmission data 1 to n addressed to terminals 1 to n. Transmission controlling section 101 selectively outputs inputted transmission data 1 to n to error correction coding section 102.

Error correction coding section 102 performs error correction coding on the data inputted from transmission controlling section 101 and transmits the obtained encoded data to modulating section 103. Modulating section 103 performs modulating processing such as QPSK (Quadrature Phase Shift Keying) and 16 QAM (Quadrature Amplitude Modulation) on the encoded data and transmits the obtained modulated signal to frame forming section 104.

Frame forming section 104 forms a transmission Frame signal by adding a pilot signal (PL) to the modulated signal, and transmits the transmission frame signal to scrambling processing section 105. Scrambling processing section 105 performs scrambling processing using a scrambling code which is unique to a cell, and transmits the scrambled signal to subcarrier allocating section 106.

Subcarrier allocating section 106 receives a synchronization channel sequence signal formed by synchronization channel sequence forming section 107, in addition to the transmission data from scrambling processing section 105. Subcarrier allocating section 106 allocates the synchronization channel sequence signal to subcarriers, such that the synchronization channel is repeated in units of the minimum bandwidth out of a plurality of bandwidths the base station supports, over the entirety of the maximum bandwidth. Further, although allocation will not be described in detail, subcarrier allocating section 106 maps scrambled signals addressed to the terminals, to subcarriers at the positions and bandwidths based on scheduling information or the like. Subcarrier allocating section 106 is configured with a serial-to-parallel converting circuit.

Inverse fast Fourier transform (IFFT) section 108 performs processing on the output of subcarrier allocating section 106, guard interval (GI) inserting section 109 inserts guard intervals, and radio transmitting section 110 performs predetermined radio processing such as digital-to-analogue conversion processing and up-conversion processing into radio frequency, and then transmits the result from antenna 111.

Next, the configuration of terminal 200 shown in FIG. 5 will be described. Terminal 200 inputs a signal received at antenna 201 to radio receiving section 202. Radio receiving section 202 obtains a baseband OFDM signal by performing predetermined radio processing such as down-conversion processing and analogue-to-digital conversion processing on the received signal.

The baseband OFDM signal outputted from radio receiving section 202 is inputted to fast Fourier transform (FFT) section 206 after guard intervals are removed by guard interval (GI) removing section 205.

Further, the baseband OFDM signal is inputted to bandwidth determining section 203. Bandwidth determining section 203 determines, for the OFDM signal obtained in each band, the magnitude of the correlation value between the part from which the guard interval was made and the guard interval part in the signal created by shifting the OFDM signal by an effective symbol length, for example, and determines the maximum bandwidth base station 100 supports, based on this magnitude of the correlation value. Symbol timing detecting section 204 detects a symbol timing by detecting a peak of the correlation value calculated by bandwidth determining section 203, for example. FFT section 206 obtains the signal before IFFT processing by performing FFT processing at the symbol timing (FFT window timing) detected by symbol timing detecting section 204, and transmits the signal to subcarrier selecting sections 207 and 209. Subcarrier selecting section 207 transmits a subcarrier signal designated in scheduling information transmitted using a control channel, for example, to descrambling processing section 208.

Subcarrier selecting section 209 selects a subcarrier signal of the minimum bandwidth out of a plurality of bandwidths the base station supports, and transmits the subcarrier signal to SCH correlation value calculating section 210 and pilot correlation value calculating section 212.

SCH correlation value calculating section 210 calculates correlation values between a synchronization channel signal outputted from subcarrier selecting section 209 and synchronization channel sequence signal replicas on a per minimum bandwidth basis, and transmits the correlation values to frame timing/code group detecting section 211.

Frame timing/code group detecting section 211 detects the frame timing and the code group by detecting the peak of correlation values. Pilot correlation calculating section 212 calculates correlation values between a signal outputted from FFT section 206 and a plurality of scrambling code candidates (that is, calculates correlation values between the scrambled pilot mapped at the beginning of the frame and a plurality of scrambling code candidates) at the timing of the beginning of the frame, and transmits the correlation values to scrambling code identifying section 213. Scrambling code identifying section 213 identifies the scrambling code yielding the maximum correlation value as the scrambling code used at base station 100, and transmits the identified scrambling code to descrambling processing section 208.

Descrambling processing section 208 descrambles the signal outputted from subcarrier selecting section 207 using the identified scrambling code. The descrambled signal is demodulated by demodulating section 214, and decoded by decoding section 215, and the received data is obtained.

Next, the operations of base station 100 and terminal 200 of this embodiment will be described using FIG. 5.

For example, as shown in FIG. 1, base station 100 generates an OFDM symbol of an SCH from a symbol sequence common to all base stations, time-multiplexes the OFDM symbol with frame data, and inserts the result to the scrambled frame.

An SCH symbol sequence pattern has a size equivalent to the number of subcarriers of the minimum bandwidth (for example, 1.25 MHz) in the scalable bandwidth. Subcarrier allocating section 106 maps an SCH of the minimum bandwidth repeatedly.

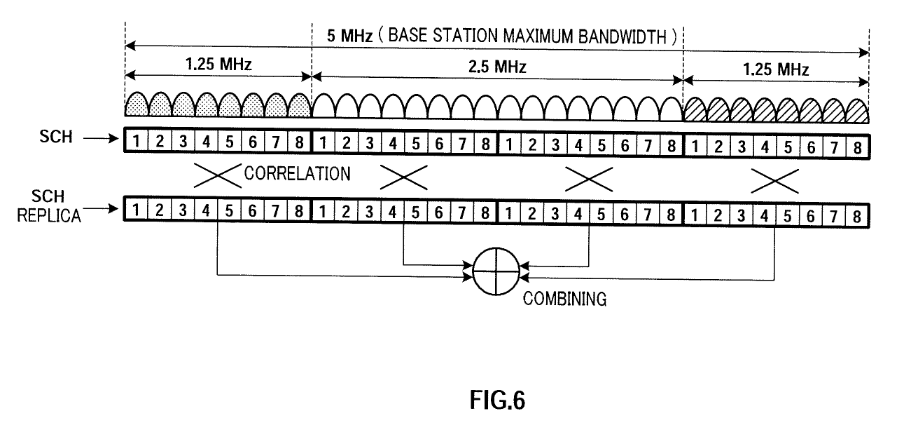

The SCH mapping method will be described in detail using FIG. 6. It is assumed that the maximum bandwidth that can be transmitted by base station 100 is 5 MHz and a data signal is transmitted using the bandwidths divided into 1.25 MHz, 2.5 MHz and 1.25 MHz. For ease of explanation, it is assumed that the number of subcarriers equivalent to the minimum bandwidth (1.25 MHz) in the scalable bandwidth is eight. As shown in FIG. 6, base station 100 maps an SCH pattern having a size equivalent to the 1.25 MHz bandwidth repeatedly regardless of details of service bandwidths.

Terminal 200 performs the following processing upon receiving this signal. When the upper limit of the frequency bandwidth (capability) that can be received by terminal 200 is greater (2.5 MHz, 5 MHz, 10 MHz, 15 MHz and 20 MHz) than the minimum bandwidth (1.25 MHz), SCH correlation value calculating section 210 of terminal 200 combines SCH correlation values as shown in FIG. 6. That is, SCH correlation value calculating section 210 combines the correlation values calculated per minimum bandwidth and detects the timing yielding the maximum combined correlation value as the frame timing. By this means, it is anticipated that the accuracy of frame timing detection will improve. Further, SCH correlation value calculating section 210 can perform SCH correlation processing by selecting one or a plurality of synchronization channels transmitted in the minimum bandwidth out of the synchronization channels that are transmitted repeatedly over the entirety of the maximum bandwidth. By this means, it is not necessary to perform correlation processing in all minimum bandwidths, so that it is possible to reduce cell search processing load.

As described above, according to this embodiment, by providing base station 100 that transmits a synchronization channel repeatedly in units of the minimum bandwidth (for example, in units of 1.25 MHz) out of a plurality of bandwidths a system uses to provide services, over the entirety of the maximum bandwidth (for example, 5 MHz), and terminal 200 that calculates correlations between a synchronization channel sequence signal of the minimum bandwidth unit provided in advance and the synchronization channels transmitted repeatedly, and detects the timing yielding the maximum correlation value as the frame timing, terminal 200 can calculate SCH correlation values accurately without knowing details of services in the maximum bandwidth of base station 100.

A case has been described with the above embodiment where base station 100 transmits a synchronization channel repeatedly without intervals in units of the minimum bandwidth (for example, in units of 1.25 MHz) out of a plurality of bandwidths the system uses to provide services, over the entirety of the maximum bandwidth (for example, 5 MHz), but this is by no means limiting, and, for example, it is also possible to transmit a synchronization channel of the minimum bandwidth unit in the frequency domain at regular intervals. Further, the present invention is not limited to a case where a synchronization sequence of the minimum bandwidth unit is repeatedly transmitted over the entirety of the maximum bandwidth the base station supports, because, when a band to be used is limited in advance within the maximum bandwidth, for example, it is only necessary to transmit a synchronization channel of the minimum bandwidth unit repeatedly over the frequency domain only in the limited band.

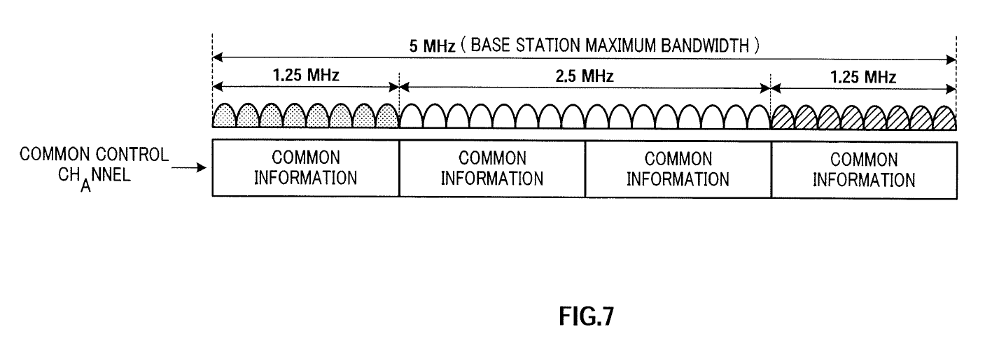

Further, a case has been described with the above embodiment where a synchronization channel is repeatedly transmitted, but, as shown in FIG. 7, the base station may transmit a common control channel repeatedly in the frequency domain in units of the minimum bandwidth out of a plurality of service bandwidths. By this means, the terminal is able to know common control information transmitted using a common control channel without knowing details of services with respect to all bandwidths of the base station, so that it is possible to perform SCH correlation processing.

Further, if base station 100 transmits an SCH or common channel repeatedly such that the center frequency of the SCH or common channel matches the raster frequency, and terminal 200 performs frame timing detecting processing such as described above using a signal received based on the raster frequency, the terminal is able to detect frequencies in use in a simple manner upon carrier frequency search, and this is further preferable.

This will be described below. The terminal generally performs carrier frequency search before cell search. Carrier frequency search allows providers to check whether or not frequencies that can be used for services are in use, receives a radio signal on a per raster frequency basis (for example, 20 kHz), and detects a frequency to be used based on an RSSI (Received Signal Strength Indicator) of the radio signal. This carrier frequency search (for example, see Japanese Patent Application Laid-Open No. 2002-300136 and Japanese Patent Application Laid-Open No. 2003-134569) and raster frequency (for example, see 3GPP TS 25.101 V6.9.0) are known techniques, and will not be described in detail.

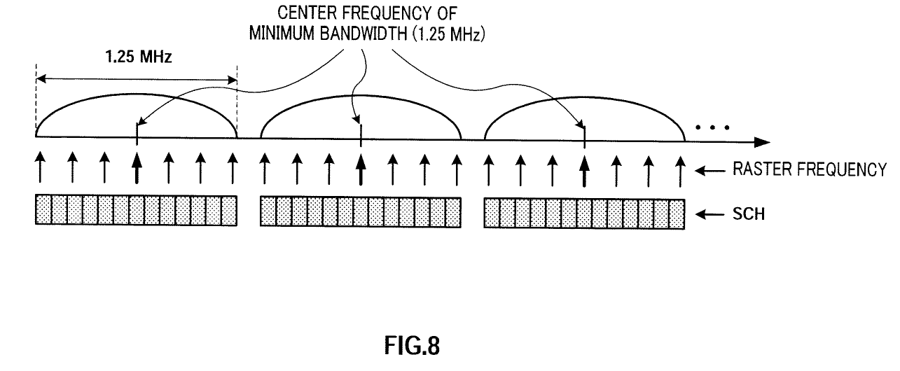

In addition to the above-described embodiment, utilizing these ideas of carrier frequency search and raster frequency, the present invention proposes mapping an SCH using the raster frequency as a reference at the base station and performing carrier frequency search on a per raster frequency basis at the terminal. That is, as shown in FIG. 8, the base station maps an SCH such that the center frequency of the SCH of the minimum bandwidth (1.25 MHz) matches the raster frequency. To be more specific, subcarrier allocating section 106 of base station 100 in FIG. 4 maps an SCH to subcarriers such that the center frequency of a synchronization channel (SCH) formed by synchronization channel sequence signal forming section 107 matches the raster frequency. Radio receiving section 202 of terminal 200 in FIG. 5 performs receiving processing on a per raster frequency basis.

### Embodiment 2

Features of this embodiment include repeating transmitting a synchronization channel at the base station such that synchronization channel sequence signals match between a plurality of bandwidths providing services in a specific frequency band. By this means, even if the bandwidth providing a service is changed, the details of the synchronization channel sequence signals are the same in the specific frequency band, so that the terminal is able to calculate synchronization channel correlation values in the specific frequency band accurately.

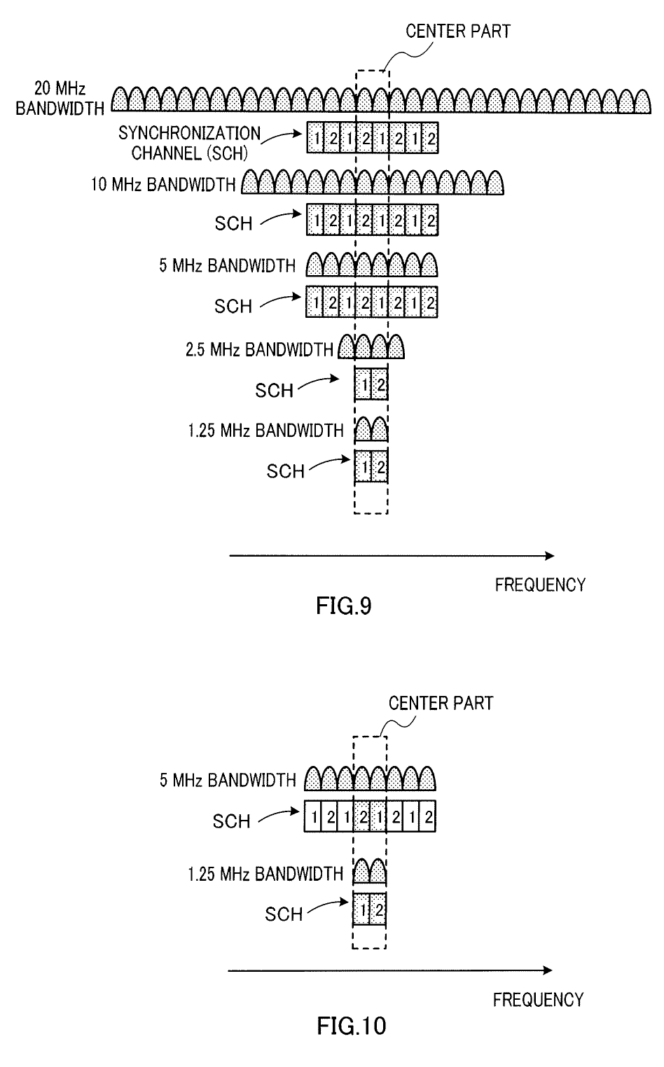

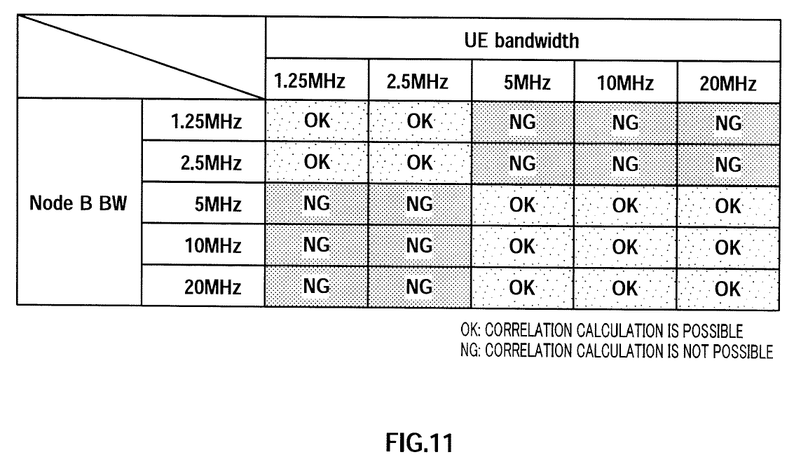

First, the reason this embodiment is proposed will be described using FIG. 9, FIG. 10 and FIG. 11.

The present inventors have focused on the fact that a method of transmitting a synchronization channel (SCH) by mapping the synchronization channel to a center part of the maximum bandwidth (for example, 20 MHz) in the scalable bandwidth system has been proposed.

FIG. 9 shows relationships between the bandwidth providing services and the SCH in this scalable bandwidth system. As can be seen from FIG. 9, the base station aligns center frequencies of bands of a plurality of bandwidths providing services (1.25 MHz, 2.5 MHz, 5 MHz, 10 MHz and 20 MHz). Further, when a bandwidth providing services is less than 5 MHz, the base station transmits an SCH using a 1.25 MHz bandwidth, and, when a bandwidth providing services is equal to or greater than 5 MHz, the base station transmits an SCH using a 5 MHz bandwidth. Further, the base station also aligns center frequencies of the SCH between bandwidths.

In this scalable bandwidth system, even if the bandwidth providing a service is changed, the SCH is always included in a fixed bandwidth including a center frequency, and so, even if the bandwidth providing a service is changed, there is an advantage that the terminal can detect an SCH in a simple manner.

If the method of transmitting a synchronization channel repeatedly in the frequency domain in units of the minimum bandwidth out of a plurality of bandwidths providing services, as described in Embodiment 1, is applied to this scalable bandwidth system, the following problems may occur.

For example, as shown in FIG. 9, if the details of the SCH (that is, a pattern of a sequence signal forming the SCH) varies in the center part, and, when the bandwidth of the base station (Node B BW) is different from the bandwidth of the terminal (UE bandwidth) as shown in FIG. 11, the terminal is not able to calculate SCH correlations and, consequently, may not be able to perform cell search processing.

FIG. 10 compares a 1.25 MHz bandwidth and a 5 MHz bandwidth as an example where the SCH pattern varies in the center part. As shown in FIG. 10, when an SCH pattern of pattern “1, 2” is repeatedly transmitted in units of the minimum bandwidth (1.25 MHz), the SCH pattern in the center part of 5 MHz becomes “2, 1.” In this case, when only a signal of pattern “1, 2” is prepared for an SCH replica with which correlation should be calculated, the terminal is not able to calculate correlations accurately. To avoid this case, SCH replicas of pattern “1, 2” and a pattern “2, 1” may be prepared for SCH replicas, but the configuration becomes complicated.

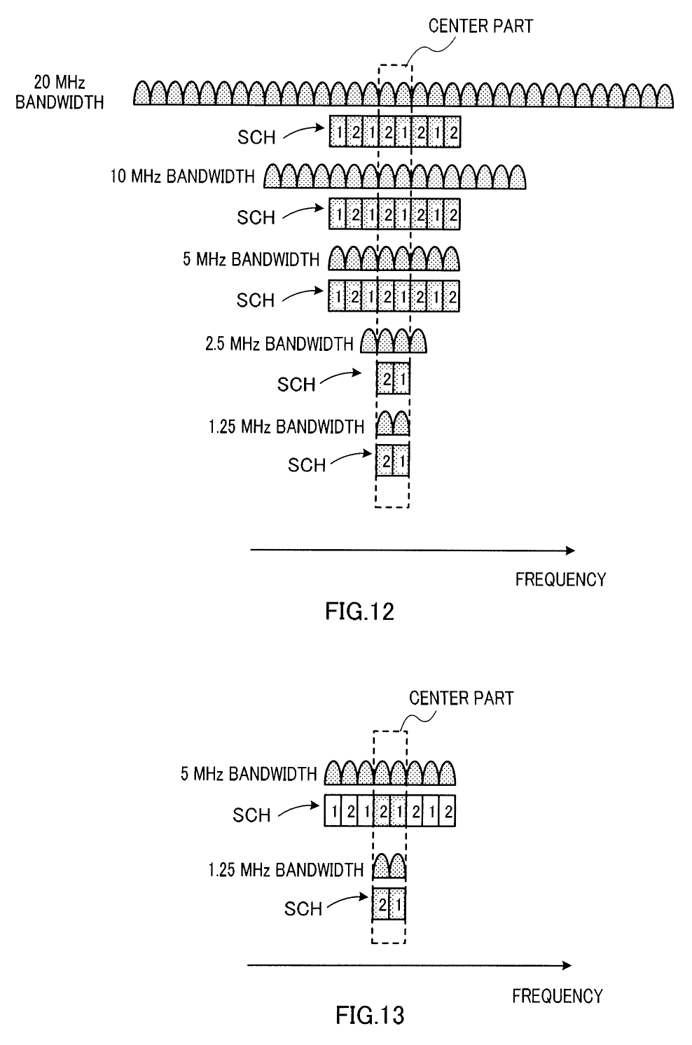

In this embodiment, as shown in FIG. 12 and FIG. 13, by controlling one of the SCH patterns out of the SCH patterns of a plurality of bandwidths providing services, the SCH patterns in the center part are always made to match between a plurality of bandwidths providing services. In the examples of FIG. 12 and FIG. 13, SCH patterns of service bandwidths, 1.25 MHz and 2.5 MHz are reversed. By this means, SCH patterns in the center part match between all bandwidths providing services (1.25 MHz, 2.5 MHz, 5 MHz, 10 MHz and 20 MHz). As a result, the terminal is able to calculate correlation values in all bandwidths (1.25 MHz, 2.5 MHz, 5 MHz, 10 MHz and 20 MHz) correctly using only one SCH replica of pattern “2, 1.”

The above-described control can be realized in a simple manner by synchronization channel sequence signal forming section 107 in FIG. 4 by changing a synchronization channel sequence signal to be formed.

As described above, according to this embodiment, when the method described in Embodiment 1 is applied to a method of transmitting an SCH by mapping the SCH at the center part of the maximum bandwidth, by making SCH sequence signals match between a plurality of bandwidths providing services in the frequency band of the center part, it is possible to calculate correlation values in all bandwidths (1.25 MHz, 2.5 MHz, 5 MHz, 10 MHz and 20 MHz) accurately using only one sequence signal.

The above-described embodiment assumes a case of applying the method described in Embodiment 1to the method of transmitting an SCH by mapping the SCH at the center part of the maximum bandwidth, and so a case has been described with the above embodiment where the frequency band where SCH sequence signals are made to match is the center part (center frequency band) of the maximum bandwidth, but the frequency band where SCH sequence signals are made to match between a plurality of bandwidths providing services is not limited to this. The point is to make SCH sequence signals match in a specific frequency band where an SCH pattern is to be detected.

The present application is based on PCT/JP05/015296, filed on Aug. 23, 2005, PCT/JP05/020311, filed on Nov. 4, 2005, and Japanese Patent Application No. 2006-004152, filed on Jan. 11, 2006, the entire content of which is expressly incorporated by reference herein.

### INDUSTRIAL APPLICABILITY

The scalable bandwidth system, radio base station apparatus, synchronization channel transmission method and transmission method of the present invention are widely applicable to scalable bandwidth systems, radio base station apparatuses and radio terminal apparatuses that are required to perform synchronization channel (SCH) correlation processing even when terminals do not know details of services with respect to all bandwidths.

1. A scalable bandwidth system that enables a radio base station apparatus to support a plurality of maximum bandwidths and flexibly allocate bandwidths radio terminal apparatuses actually use to carry out communication, from the maximum bandwidths, the system comprising:
a radio base station apparatus that transmits a synchronization channel repeatedly in a frequency domain in units of a minimum bandwidth out of a plurality of bandwidths providing services; and
a radio terminal apparatus that calculates correlations between a synchronization channel sequence signal of the minimum bandwidth unit provided in advance and the synchronization channels transmitted repeatedly, and detects a timing yielding a maximum correlation value as a frame timing.

2. The scalable bandwidth system according to claim 1, wherein the radio terminal apparatus combines the correlation values calculated per minimum bandwidth, and detects a timing yielding a maximum combined correlation value as a frame timing.

3. The scalable bandwidth system according to claim 1, wherein the radio terminal apparatus calculates correlations selectively using a synchronization channel transmitted in one or a plurality of frequency bands, out of the synchronization channels transmitted repeatedly in the frequency domain.

4. The scalable bandwidth system according to claim 1, wherein the minimum bandwidth is 1.25 MHz.

5. The scalable bandwidth system according to claim 1, wherein the radio base station apparatus transmits the synchronization channel repeatedly such that a center frequency of the synchronization channel matches a raster frequency; and
the radio terminal apparatus detects the frame timing using a signal received based on the raster frequency as a reference.

6. The scalable bandwidth system according to claim 1, wherein the radio base station transmits the synchronization channel repeatedly such that synchronization channel sequence signals match between a plurality of bandwidths providing services, in a specific frequency band.

7. The scalable bandwidth system according to claim 6, wherein the specific frequency band is a center frequency band of the supported maximum bandwidths.

8. A radio base station apparatus used in a scalable bandwidth system that enables the radio base station apparatus to support a plurality of maximum bandwidths and flexibly allocate bandwidths radio terminal apparatuses actually use to carry out communication from the maximum bandwidths, the radio base station apparatus transmitting a synchronization channel repeatedly in a frequency domain in units of a minimum bandwidth out of a plurality of bandwidths providing services.

9. The radio base station apparatus according to claim 8, wherein the synchronization channel is transmitted repeatedly such that a center frequency of the synchronization channel matches a raster frequency.

10. The radio base station apparatus according to claim 8, wherein the synchronization channel is transmitted repeatedly such that synchronization channel sequence signals match between a plurality of bandwidths providing services, in a specific frequency band.

11. The radio base station apparatus according to claim 10, wherein the specific frequency band is a center frequency of the supported maximum bandwidths.

12. A synchronization channel transmission method used in a scalable bandwidth system that enables a radio base station apparatus to support a plurality of maximum bandwidths and flexibly allocate bandwidths radio terminal apparatuses actually use to carry out communication, from the maximum bandwidths, the synchronization channel transmission method comprising transmitting a synchronization channel repeatedly in a frequency domain in units of a minimum bandwidth out of a plurality of bandwidths providing services.

13. A radio base station apparatus used in a scalable bandwidth system that enables the radio base station apparatus to support a plurality of maximum bandwidths and flexibly allocate bandwidths radio terminal apparatuses actually use to carry out communication, from the maximum bandwidths, the radio base station apparatus transmitting a common control channel repeatedly in a frequency domain in units of a minimum bandwidth out of a plurality of bandwidths providing services.

14. A transmission method of a radio base station apparatus used in a scalable bandwidth system that enables the radio base station apparatus to support a plurality of maximum bandwidths and flexibly allocate bandwidths radio terminal apparatuses actually use to carry out communication, from the maximum bandwidths, the transmission method comprising transmitting a common pilot channel repeatedly in a frequency domain in units of a minimum bandwidth out of a plurality of bandwidths providing services.
